(19) United States
(12) Patent Application Publication
(10) Pub. No.: US 2017/0289021 A1
(43) Pub. Date: Oct. 5, 2017

(54) PACKET SEQUENCE NUMBERING FOR MULTI-CONNECTIVITY IN A WIRELESS NETWORK

(71) Applicant: Nokia Solutions and Networks Oy, Espoo (FI)

(72) Inventors: Mikko Säily, Laukkoski (FI); Henri Markus Koskinen, Espoo (FI); Jarmo Tapani Mäkinen, Espoo (FI)

(21) Appl. No.: 15/508,211

(22) PCT Filed: Oct. 13, 2014
(86) PCT No.: PCT/EP2014/071829

§ 371 Date: Mar. 2, 2017

(30) Foreign Application Priority Data
Sep. 2, 2014 (US) 14475388

(51) Int. Cl. H04L 12/707; H04L 12/801; H04L 12/803; H04W 76/02; H04W 74/00

(52) U.S. Cl. CPC H04L 45/24; H04W 76/025; H04W 74/002; H04L 47/125; H04L 47/34; H04W 48/16

(57) ABSTRACT

An example technique may include controlling receiving a data unit and an associated first sequence number over a first protocol, assigning a second sequence number to the data unit, wherein the second sequence number is based upon the first sequence number, and controlling transmitting, over a second protocol, the data unit and the second sequence number.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

### SUMMARY

According to an example implementation, a method may include controlling receiving a data unit and an associated first sequence number over a first protocol, assigning a second sequence number to the data unit, wherein the second sequence number is based upon the first sequence number, and controlling transmitting, over a second protocol, the data unit and the second sequence number.

According to another example implementation, an apparatus may include at least one processor and at least one memory including computer instructions, when executed by the at least one processor, cause the apparatus to control receiving a data unit and an associated first sequence number over a first protocol, assign a second sequence number to the data unit, wherein the second sequence number is based upon the first sequence number, and control transmitting, over a second protocol, the data unit and the second sequence number.

According to another example implementation, a computer program product may include a non-transitory computer-readable storage medium and storing executable code that, when executed by at least one data processing apparatus, is configured to cause the at least one data processing apparatus to perform a method including: controlling receiving a data unit and an associated first sequence number over a first protocol, assigning a second sequence number to the data unit, wherein the second sequence number is based upon the first sequence number, and controlling transmitting, over a second protocol, the data unit and the second sequence number.

According to another example implementation, an apparatus may include means for controlling receiving a data unit and an associated first sequence number over a first protocol, means for assigning a second sequence number to the data unit, wherein the second sequence number is based upon the first sequence number, and means for controlling transmitting, over a second protocol, the data unit and the second sequence number.

According to another example implementation, a method may include controlling receiving, via a first protocol, sequence number information, determining, based upon the sequence number information received via the first protocol, a second protocol sequence number for each of a plurality of second protocol data units that are part of a multiple connection session, assigning one of the determined second protocol sequence numbers to each of a plurality of the second protocol data units, and controlling transmitting one or more of the second protocol data units over the second protocol, each of the second protocol data units including the assigned sequence number.

According to another example implementation, an apparatus may include at least one processor and at least one memory including computer instructions, when executed by the at least one processor, cause the apparatus to: control receiving, via a first protocol, sequence number information, determine, based upon the sequence number information received via the first protocol, a second protocol sequence number for each of a plurality of second protocol data units that are part of a multiple connection session, assign one of the determined second protocol sequence numbers to each of a plurality of the second protocol data units, and control transmitting one or more of the second protocol data units over the second protocol, each of the second protocol data units including the assigned sequence number.

According to another example implementation, a computer program product includes a non-transitory computer-readable storage medium and storing executable code that, when executed by at least one data processing apparatus, is configured to cause the at least one data processing apparatus to perform a method including: controlling receiving, via a first protocol, sequence number information, determining, based upon the sequence number information received via the first protocol, a second protocol sequence number for each of a plurality of second protocol data units that are part of a multiple connection session, assigning one of the determined second protocol sequence numbers to each of a plurality of the second protocol data units, and controlling transmitting one or more of the second protocol data units over the second protocol, each of the second protocol data units including the assigned sequence number.

According to yet another example implementation, an apparatus may include means for controlling receiving, via a first protocol, sequence number information, means for determining, based upon the sequence number information received via the first protocol, a second protocol sequence number for each of a plurality of second protocol data units that are part of a multiple connection session, means for assigning one of the determined second protocol sequence numbers to each of a plurality of the second protocol data units, and means for controlling transmitting one or more of the second protocol data units over the second protocol, each of the second protocol data units including the assigned sequence number.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating an example implementation of a user device and a core network in which multiple connectivity may be provided for the user device.

FIG. 3 is a block diagram illustrating a network according to an example implementation.

FIG. 4 is a flow chart illustrating operation of a network entity according to an example implementation.

FIG. 5 is a flow chart illustrating operation of a network entity according to another example implementation.

FIG. 6 is a diagram illustrating operation of a network entity according to an example implementation.

FIG. 7 is a diagram illustrating operation of network entities of a multiple connection session according to an example implementation.

FIG. 8 is a block diagram of a network entity or other wireless device according to an example implementation.

FIG. 9 is a block diagram illustrating a network entity according to an example implementation.

### DETAILED DESCRIPTION

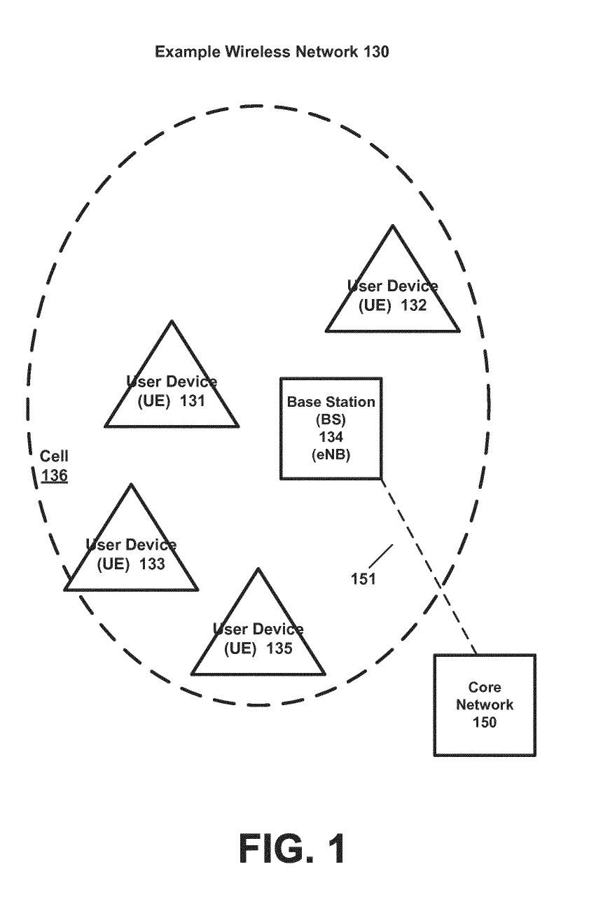

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B or BS may be also be carried out by any network entity, such as a wireless node, a network node, a server or host which may be operably coupled to a transceiver, such as a remote radio head, or other network entity. The term base station or BS is used in some of the illustrative examples described herein, but it is understand that the various functions described as being performed by a BS may be performed by any network entity. BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

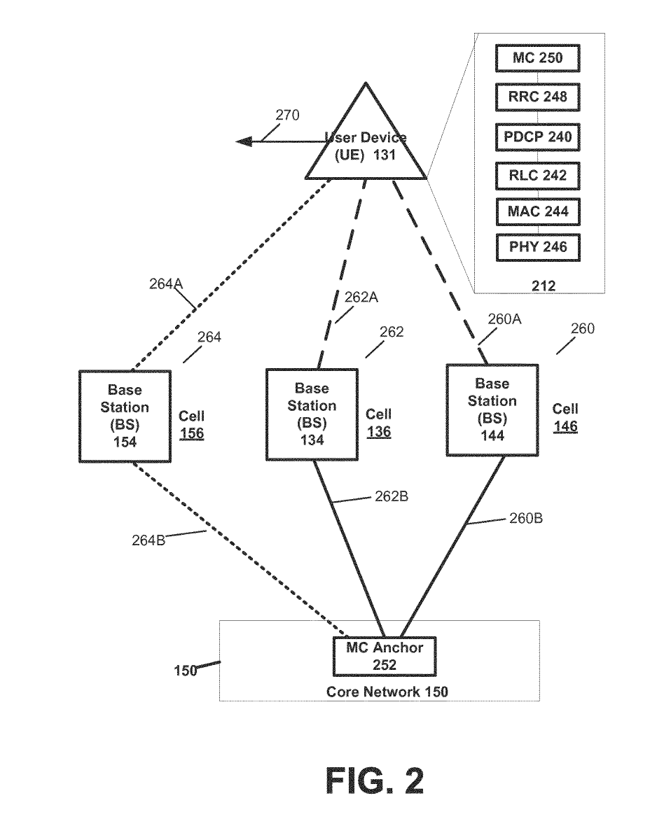

FIG. 2 is a diagram illustrating an example implementation of a user device and a core network in which multiple connectivity (e.g., dual connectivity) may be provided for the user device. According to an example implementation, multiple connectivity (or multi-connectivity) may be provided as a multiple connection (MC) session wherein data is communicated between a user device 132 and core network 150 via two or more independent connections, including independent wireless connections. Also, according to an example implementation, each connection (or a plurality of connections) of the MC session may be provided between the user device 131 and the core network 150 via different cells.

Referring to FIG. 2, example user device 131 may include at least one radio protocol stack 212 that may be implemented in hardware and/or software. According to an example implementation, a protocol stack may include logic, and/or computer instructions executed by a processor to perform the functions or operations for each entity of the protocol stack. An example protocol stack 212 for a user device 131 may include, for example, a Multiple Connection (MC) entity 250, a Packet Data Convergence Protocol (PDCP) entity 240, a Radio Link Control (RLC) entity 242, a Media Access Control (MAC) entity 244, a Physical layer (PHY) entity 246, and a Radio Resource Control (RRC) entity 248.

The PDCP entity 240 may, for example, perform ciphering (encryption and decryption of data) and header compression-decompression. The RLC entity 242 may, for example, perform segmentation/concatenation, error detection and correction, data retransmission, duplicate detection and in-sequence data delivery to higher layers. According to an example implementation, there may be one RLC corresponding to one logical channel. MAC entity 244 performs multiplexing of logical channels (where there may be one or more logical channels), hybrid ARQ (HARQ) retransmissions (where ARQ may refer to automatic repeat request), inserting of MAC control elements (MAC CEs) used for in-band control signaling, and other MAC-related functions. The PHY entity 246 handles or performs coding/decoding, modulation/demodulation, multi-antenna mapping, and other physical layer functions. Multiple RLC entities within a user device may share one MAC entity 244 and one PHY entity 246. RRC entity 248 may be responsible for handling a number of functions or procedures related to the Radio Access Network (RAN).

Referring again to the example radio protocol stack 212 of user device 131, the MC entity 250 may, for example, perform user device functions associated with establishing, management and/or control of one or more multiple connection (MC) sessions that may be established between user device 131 and core network 150. As noted, a multiple connection session may include a session wherein data is communicated between user device 131 and core network 150 via two or more independent connections, including two or more independent wireless connections. The data transmitted within the MC session may be for one application running on the user device 131, or may include data for multiple applications (e.g., voice data, text data from a text/messaging application, data from a web browser, . . . ) running on the user device.

According to an example implementation, user device 131 may include a radio protocol stack 212 for each independent connection or each independent wireless connection. Also, one MC entity 250 may be shared among multiple connections for a MC session. The multiple independent wireless connections for a MC session may be provided for the same radio access technology (RAT), or among different RATs (e.g., LTE, wireless LAN/WLAN, 3G, EDGE, . . . ). In some cases, a MAC entity 244 and a PHY entity 246 may be shared among multiple independent wireless connections for a MC session where the wireless connections are for the same RAT.

As shown in the illustrative example of FIG. 2, a user device 131 may be coupled to a core network 150 via a plurality of cells, including, for example, via a cell 136 that is provided by BS 134, and a cell 146 that is provided by BS 144. Thus, in this example shown in FIG. 2, user device 131 may be coupled to core network 150 via two independent connections, where each connection may include: an independent wireless connection between the user device 131 and a cell, and a backhaul connection between the cell and the core network 150. For example, as shown in FIG. 2, a MC session may be established including multiple connections between user device 131 and core network 150, including a connection 260 provided via cell 146, which includes wireless connection 260A and backhaul connection 260B, and a connection 262 provided via cell 136, which includes a wireless connection 262A and a backhaul connection 262B. In this illustrative example, the MC session includes only two connections, but any number of connections may be provided as part of a MC session.

The wireless connections 260A and 262A may be considered to be independent wireless connections because each of the wireless connections are managed separately by the user device 131 or by core network 150, and a failure (or break) or disconnection of any of the wireless connections of the MC session does not cause (or result in) a failure or disconnection of any other wireless connections of the MC session. Thus, for example, as independent wireless connections, a failure or disconnection of wireless connection 260A does not cause a failure or disconnection to wireless connection 262A, and a failure or disconnection of wireless connection 262A does not cause a failure or disconnection to wireless connection 260A. This is in contrast to a use of a primary cell (Pcell) and a secondary cell (Scell), where a failure or disconnection of a connection established via the Pcell will cause a disconnection of the connection established via the Scell.

According to an example implementation, due to independent connections (e.g., including independent wireless connections), in the event of a failure or a disconnection (or other problem) of one of the connections of the MC session, all of the data for the MC session may be communicated between the user device 131 and core network 150 via the other remaining connection(s)/cell(s) of the MC session, while the user device re-establishes a new connection to replace the failed/disconnected connection for the MC session, for example. Similarly, in the event that the user device performs a handover for one of the connections of the MC session, all of the data for the MC session may be communicated via the one or more other connections/cells of the MC session during such handover procedure, until a new connection is established and added to the MC session, for example. In this manner, one or more of the example implementations may assist in providing improved connection robustness and may be more likely to result in an uninterrupted wireless service for a user device. Likewise, for load balancing or other objective, a first BS/cell may request a second BS/cell of the MC session to transmit or retransmit a data unit(s) that may have been originally transmitted (or requested by core network or user device to transmit).

Referring to FIG. 2, core network 150 may include, for example, a multiple connection (MC) anchor 252 which may perform core network functions associated with establishing, management and/or control of one or more multiple connection (MC) sessions, such as, for example, for a MC session that may be established between user device 131 and core network 150.

According to an example implementation, a data unit (or packet) numbering may be provided at a layer or entity above the PDCP entity, e.g., to allow a common set of data unit sequence numbers to be applied or used for all data units among the multiple connections/cells within a MC session. For example, in the downlink direction towards the user device 131, MC anchor 252 may receive data packets (or data units) for the MC session, provide or add a MC session sequence number to each data unit, duplicate each of the data units (for transmission to multiple cells/BSs of the MC session), and forward or send all of the data units for the MC session to each cell or BS providing a connection to the user device for the MC session. In the uplink direction (data from the user device to the core network) for the MC session, the MC anchor 252 may receive one or more data units from each of the cells (but, in an example implementation, typically not receive the same data unit from multiple cells) for the MC session, may reorder the received data units as necessary based on a MC session sequence number for each MC session data unit, and then may forward the data units via the Internet or other data network.

In an example implementation, each cell (or BS providing the cell) that is part of the MC session (or each cell/BS that provides a connection of the MC session), may receive and store all the downlink data units of the MC session from the MC anchor 252. Therefore, according to an example implementation, duplicate data streams for the MC session may be transmitted from MC anchor 252 (or other block of the core network) to each BS/cell (or via each connection) of the MC session, e.g., to both BS 144/cell 146 and to BS 134/cell 136. In an example implementation, the user device 131 may send a data request(s) to each cell/BS of the MC session requesting to receive one or more data units (or a group of data units) of the MC session from the cell. User device 131 may send a request to receive data unit(s) to each of the BSs/cells of the MC session, although the user device 131 may typically request (and receive) different data units of the MC session from each BS/cell/connection of the MC session. Alternatively, the core network or MC anchor 252 may instruct each BS of which data units of a MC session the cell/BS should transmit to the user device (in such case, in one example implementation, the MC anchor 252 or core network may transmit to each BS/cell only those data units to be forwarded by the cell to the user device, or in another implementation, each cell of the MC session may receive all data units of the MC session).

Thus, according to an example implementation, user device 131 may request and receive different groups of data units from each cell/BS/connection of the MC session. For example, user device 131 may send to cell 146/BS 144 a request to receive all odd-numbered (e.g., based on MC session sequence numbers) data units from cell 146 for the MC session, and user device 131 may send to cell 136/BS 134 a request to receive all even-numbered (e.g., based on MC session sequence numbers) data units from cell 136 for the MC session. This is just an example, and user device 131 may request any data units from the cells of the MC session.

According to an example implementation, each cell of a MC session may receive all the data units or packets of a MC session, including the data units to be transmitted by the cell, as well as the other data units to be transmitted (or requested by the user device for transmission) by other cells of the MC session. Therefore, according to an example implementation, duplicate downlink data streams (including all data units of the MC session) may be sent by MC anchor 252 (or other entity at the core network) to all cells of (or assigned to) the MC session. Also, according to an example implementation, the user device 131 may request any data unit from any of the cells/BSs/connections of the MC session, e.g., because all of the downlink data units of the MC session may be received and stored by each of the cells/BSs of the MC session. This may allow, for example, a splitting of downlink traffic (data units) of the MC session to the user device, e.g., where different types of traffic (e.g., data, voice) may be sent over different connections/cells, or where traffic may be allocated to one or more of the connections/cell of the MC session based on one or more criteria, such as a quality of service requested by each application using the MC session, a channel quality (e.g., packet error rate, received signal strength) of each wireless connection, etc. For example, a user device may measure a signal strength of each connection, and may request more (or a greater percentage) of data units of the MC session to be received from connections/cells having greater signal strength or lower error rate, etc., and may request less or fewer of the data units of the MC session to be received via connections/cells having a lower signal strength or higher error rate, for example.

In response to receiving one or more data units, the user device 131 may send one or more acknowledgements to one or more cells of the MC session to acknowledge receiving one or more of the data unit(s). Various techniques or implementations may be used for communication of acknowledgements. For example, the user device 131 may send an acknowledgement(s) to cell 146 that acknowledges both data units received from cell 146 and data units received from other cells (e.g., cell 136) of the MC session. Thus, if user device 131 receives all odd-numbered data units (for example) from cell 146 for the MC session and receives all even-numbered data units from cell 136, then, according to one example implementation, the user device 131 may send acknowledgements to both cells 146 and 136 that acknowledges receipt of both odd and even numbered data units. In this manner, by notifying each cell of the MC session of any received data unit (including data unit received from a different cell), the cell may discard or delete any data unit that was received by the user device 131. An acknowledgement may be provided as a first acknowledgement that acknowledges only data units transmitted by the receiving cell and a second (separate) acknowledgement (cross-cell acknowledgement) that acknowledges data units received by other cells. Or, alternatively, the acknowledgements for data units from all cells of the MC session may be combined. Also, acknowledgements sent by the user device 131 to a cell may be piggy-backed onto a data request sent to the cell. For example, a request sent by user device 131 to cell 146 to receive one or more data units from cell 146 may also include a piggy-backed acknowledgement that acknowledges that the user device 131 has received one or more other data units (received from either cell 146 or cell 136).

In another example implementation, the user device 131 may send an acknowledgement(s) to each cell to acknowledge (e.g., only) data received from such cell, and then each cell may send a message (e.g., via X2 interface or BS-to-BS interface) to the other cells/BSs of the MC session to identify the data units that have been received by the user device (e.g., based on the acknowledgement(s) received by the cell from the user device 131). Therefore, for example, cross-cell acknowledgements (e.g., acknowledging receipt of data units from other cells) may either be communicated by the user device 131, or by one or more of the cells via a BS-to-BS (or cell-to-cell) interface or communications link, for example.

Some illustrative examples will now be described regarding the operation of the user device 131, the base stations (BSs) of (or assigned to) a MC session, and the MC anchor 252. Referring to FIG. 2, user device 131 may, for example, first establish a connection 260 via cell 146/BS 144 to core network 150, and then may then establish a connection 262 via cell 136/BS 134 to core network 150. User device 131 may be assigned an ID (or identifier) that may identify the user device within each of cells 146 and 136. Thus, in this example, the user device 131 may include two identifiers. User device 131 may send a multiple connection (MC) session setup request message to MC anchor 252 via one (or both) of the connections 260 or 262 (or via cell 146 or 136), to request that the MC anchor 252 establish or setup a MC session between the user device 131 and core network 150 via the two identified connections 260, 262, or via the two identified cells 146 and 136, for example.

According to an example implementation, the MC session setup request message may include one or more fields, such as a field indicating MC session setup request, cell IDs to identify the cells 146 and 136 that are to be added (or included in) the MC session, and/or a user device identifier (e.g., a mobile station ID or MSID) identifying the user device for or within each of cells 136 and 146, as examples. After establishing the MC session, MC anchor 152 may send a MC session setup reply message to user device 131 via one or more (or both) of the connections 260, 262 indicating that the MC session has been established, and may identify a MC session ID (MC session identifier). For downlink data units addressed to directed to the user device 131, MC anchor 152 may add a MC session sequence number (e.g., above the PDCP layer) to each data unit, and then send duplicate data units (duplicate data streams) to each of the cells/connections (cell 146/BS144, and cell 136/BS 134) of (or assigned to) the MC session. The downlink data units of the MC session are received and stored by both cells/BSs (cell 146/BS 144 and cell 136/BS 134).

Data unit transmission from each cell for the MC session may, for example, be controlled by either the user device 131 or the core network 150 (or MC anchor 252). In one example implementation, the user device 131 may send a message to each of the cells (cell 136/BS134 and cell 146/BS 144) of the MC session to identify one or more (or a group) data units of the MC session that the user device 131 is requesting to receive from the cell/BS. Alternatively, the core network 150 (such as MC anchor 252) may determine and may notify each BS/cell of the MC session of which data units, or what portion or percentage of the data units, of the MC session should be sent to the user device 131.

The user device 131 or the core network may use or take into account various criteria or approaches to determine which data units or what portion of the data units should be allocated to (or sent from) each of the cells/BSs of the MC session, such as, for example, equal traffic load balancing among the connections/cells, allocating traffic among cells or connections based on channel quality or radio path conditions (e.g., received signal strength or error rate) of each connection, a traffic load on each cell or BS, priority of each data unit or of different types of traffic included in the MC session, etc. User device 131 may send acknowledgements to the cells 136 and 146 as described above. Cross-cell acknowledgements (e.g., acknowledging, to a cell, of receipt of a data unit received from another cell of the MC session) may be sent directly by the user device 131 to the cells, or may be forwarded by a cell/BS that transmitted the data unit to other cells of the MC session, for example.

In the uplink direction, the user device 131 may add a MC session sequence number to each data unit, and may forward each data unit of the MC session to one of the cells of the MC session. The same or similar criteria or conditions may be used by the user device 131 to determine how to allocate uplink data units among two or more connections/cells for a MC session, e.g., based on traffic load balancing among multiple connections/cells, allocating traffic among the multiple connections/cells based on channel quality or radio path conditions, etc. Each cell may receive and forward received data units to core network 150, where MC anchor 152 may re-order received data units into a correct order based on the MC session sequence numbers of the received data units.

Therefore, according to an example implementation, in the downlink direction, each cell or BS of the MC session may receive all data units or a duplicate data stream from the MC anchor 152, where the data units sent to both/all cells/BSs of the MC session use or provide a common sequence numbering system, and where only one cell/BS of the MC session typically sends or transmits each data unit to the user device 131 (e.g., based on a request from the user device or based on instructions from the core network). However, in some cases, a cell/BS may be requested to retransmit a data unit that was not successfully received/decoded by the user device 131 from another cell/BS. According to an example implementation, in the uplink direction, the user device 131 may add a MC session sequence number to each data unit, and then transmit or send each data unit to one of the cells/BSs of the MC session. Thus, according to an example implementation, duplicate data streams (or all data units) of the MC session are provided from MC anchor 252 to all cells of the MC session for downlink data, but not for uplink data of the MC session.

One of a variety of conditions may be detected by BS 134 or user device 131 regarding wireless connection 262A. This detected condition may cause a failure or other problem with wireless connection 262A (as an example). A user device 131 may move away from cell 136 and one of a plurality of conditions may be detected by the user device 131 with respect to cell 136 that may cause the user device 131 and/or BS 134 to re-allocate one or more data units of the MC session that were scheduled (or requested) for transmission from cell 136 to user device 131 to be re-assigned or re-allocated to cell 146 (or re-assigned or re-allocated for transmission from cell 136 or other cell(s) to user device 131).

For example, one or more of the following conditions may be detected by user device 131 (or in some cases, BS 134) with respect to wireless connection 262A: a radio link failure of the wireless connection 262A (or a detection of a failure of the wireless connection 262A), detecting that a signal quality (e.g., received signal strength) of the wireless signal for the wireless connection 262A (associated with cell 136) is less than a threshold, detecting that one or more data units sent/transmitted by cell 136 were not decoded by user device 131 (e.g., due to signal interference) or an ACK was not received by BS 134 for such transmitted data unit(s), a handover condition detected with respect to cell 136 (e.g., a received signal strength of a signal from a third cell is greater than a received signal strength from cell 136, indicating to user device 131 that a handover may or should be performed from cell 136 to the third cell (not shown) (where such handover condition may be reported to core network 150 to allow core network 150 to make handover decision for user device, or user device 131 may make its own handover decision), a decision by user device 131, BS 134/cell 136, or core network 150 to perform a handover of connection 262A from cell 136 to the third cell, and/or other detected condition or situation. These are merely some examples and other conditions or situations may be used to trigger or cause user device 131 or BS 134 to re-allocate or re-assign the transmission of one or more data units from cell 136 to one or more other cells, e.g., to cell 146 or other cell.

In response to user device 131 (or BS 134) detecting one or more of the above-noted example conditions, user device 131 may send a re-allocation message to BS 136/cell 134 notifying the cell 136 of a problem (e.g., signal strength of connection 262A below a threshold, or a handover indication for cell 136), and/or requesting cell 136 to re-allocate a transmission of data units for the MC session to one or more other cells, such as cell 146. Alternatively, BS 134/cell 136 may determine such condition with respect to wireless connection 262A. BS 134/cell 136 may then send a message (e.g., re-allocation message) to BS 144/cell 146 to request a transmission or retransmission of one or more data units (which may be have been initially allocated for transmission from or transmitted by cell 136) of the MC session from cell 146 to user device 131. Thus, such re-allocation message sent by cell 136 to cell 146 may be used to re-allocate a transmission of one or more data units from cell 136 to cell 146.

For example, if user device 131 had originally requested odd-numbered data units from cell 136/BS 134 and a last acknowledged odd-numbered data unit was sequence number 235, then upon detecting (or being notified of) one of the above-noted example conditions, BS 134/cell 136 may send a re-allocation message to BS 144/cell 146 that requests BS 144/cell 146 to also now send odd-numbered data units, or a request to send data units 237, 239, 241, etc. (the next odd-numbered data units). Alternatively, BS 134/cell 136 may simply send, for example, a request to BS 144/cell 146 to send all data units (not merely even-numbered data units) of the MC session to user device 131, which would cause cell 146/BS 144 to send any missing or next in-sequence odd-numbered data units of the MC session that were previously scheduled or allocated to cell 136 for transmission to user device 131.

According to an example implementation, each BS may typically include a protocol stack that may include one or more of the protocol entities shown for protocol stack 212, including a PDCP entity 240. According to an example implementation, after receiving data from core network 150, a cell/BS may use a PDCP entity 240 to include a PDCP sequence number for each PDCP data unit that is transmitted downlink to the user device 131 as part of the MC session. However, at least in some cases, each cell/BS may employ an independent PDCP sequence numbering. Therefore, in one example implementation of a multiple connection (MC) session where each cell receives the data units of the MC session, the two different cells (e.g., cells 136 and 146) of the MC session may use completely different (independent) PDCP sequence numbers. Therefore, the use of independent PDCP sequence numbers at each cell/BS of a MC session may make it difficult for the BSs/cells to communicate or identify PDCP data units of a MC session for transmission/retransmission. For example, cell 136 may be unable to request cell 146 to transmit or retransmit one or more PDCP data units of the MC session because different PDCP sequence numbers may be used at cells 136 and 146 for the same data unit.

Therefore, in order for cells or BSs to coordinate or re-allocate a transmission of data units of a MC session, according to an example implementation, a common sequence numbering or other technique may be used to allow two base stations/cells of the MC session to reference a common (or same) set of sequence numbers or otherwise identify the same set of data units. There are a number of different example techniques or implementations described herein that may be used to allow or to provide for communications between cells to identify data units of a MC session.

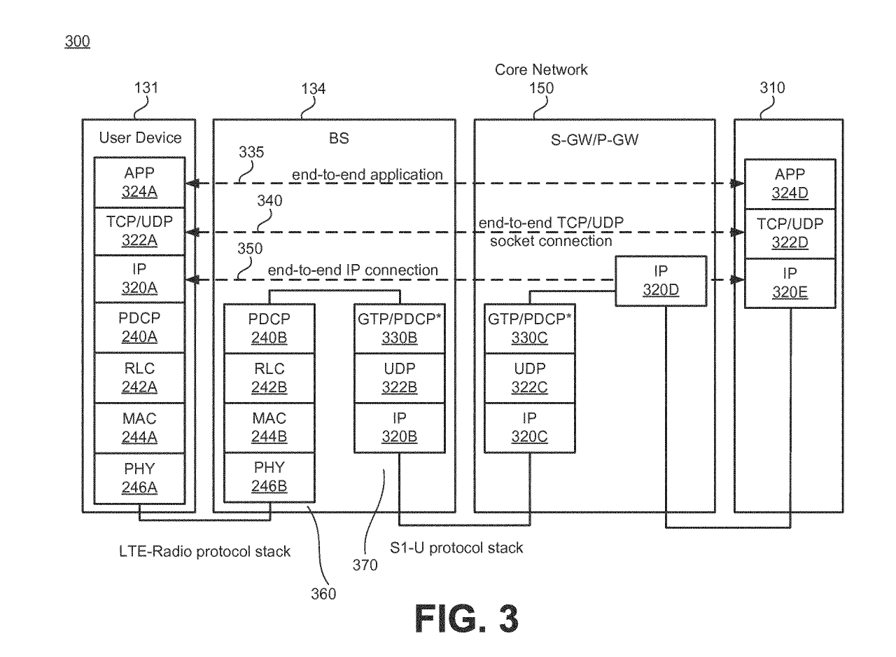

FIG. 3 is a block diagram illustrating a network according to an example implementation. Network 300 illustrates a user device 131 communicating with a host 310 via a BS 134 and core network 150. User device 131 may include a protocol stack, which may include a PHY entity 246A, a MAC entity 244A, a RLC entity 242A, a PDCP entity 240A, an internet protocol (IP) entity 320A, a TCP (transmission control protocol) and/or UDP (user datagram protocol) entity 322A, and an application entity (or application program) 324A. In this example implementation, BS 134 may include a first protocol stack 360 (e.g., a LTE radio protocol stack) for communicating with user device 131 via a wireless (or radio) connection, and a second protocol stack 370 (e.g., a LTE S1-U protocol stack) for communicating with core network 150. Protocol stack 360 may include a PHY entity 246B, a MAC entity 244B, a RLC entity 242B and a PDCP entity 240B. Protocol stack 370 may include, for example, an IP entity 320B, a UDP (or a TCP/UDP) entity 322B, and a GTP entity 330B, where GTP entity 330B may include a GPRS (General Radio Packet Service) tunneling protocol entity.

Core network 150 may include a serving gateway (S-GW), a primary gateway (P-GW) and/or a MC anchor 252. Core network 150 may include a protocol stack that includes, for example, IP entities 320C and 320D, a UDP (or TCP/UDP) entity 322C, and a GTP entity 330C. IP entity 320C may be coupled over an S1 interface to a peer IP entity 320B at BS 134. IP entity 320D may be coupled over an IP network (not shown) to a peer IP entity 320E at a host 310. Host 310 may also include a TCP/UDP entity 322D and an application entity 324D.

Therefore, as shown in FIG. 3, application entity 324A at user device 131 may communicate with a peer application entity 324D at host 310 via an end-to-end application connection 335, for example. TCP/UDP entity 322A at user device 131 may communicate with a peer TCP/UDP entity 322D at host 310 via an end-to-end TCP/UDP socket connection 340. IP entity 320A at user device may also communicate with IP entity 320E via IP entity 320D and via an end-to-end IP connection 350, for example.

A multiple connection (MC) session may be established between user device 131 and core network 150 via cells 136 and 146 (for example), which may improve data throughput or data rate and reliability. Thus, the MC session may include independent wireless connections, including a first wireless connection to cell 136/BS 134 and a second wireless connection to cell 146/BS144. According to an example implementation, GTP entity 330C of core network 150 may receive data (e.g., directed to or addressed to application 324A of user device 131) from application entity 324D of host 310 for the MC session. GTP entity 330C at core network 150 may then generate GTP data units for the MC session and forward these GTP data units to GTP entity 330B of BS 134 for cell 136, and to a similar GTP entity of BS 144 for cell 146.

Also, according to an example implementation, GTP protocol entities 330B and 330C may exchange GTP data units, but the GTP protocol/data units do not (in this example) extend to user device 131. In other words, the GTP protocol extends between core network and BSs 134, 144, but does not extend to the user device in this illustrative example. Rather, protocol entities, such as PDCP entity 240A (at user device 131) and PDCP entity 240B (at the BS 134), as examples, may be used to communicate or exchange data between the user device 131 and BS 134 (both in the uplink and downlink directions). According to some example implementations, sequence number information may be included within the GTP data units sent from core network 150 to each BS 134, 144, where this sequence number information may either include PDCP sequence numbers to be used by the BS or may include information that allows each cell/BS of the MC session to determine a consistent set of PDCP sequence numbers for PDCP data units to be transmitted to the user device 131. In this manner, each BS/cell of a MC session may use a common or consistent set of PDCP sequence numbers. In an alternative implementation, each BS may store a mapping or association between (e.g., cell-specific) PDCP sequence numbers used between the cell and user device, and the GTP sequence numbers used between core network 150 and the BS. According to an example implementation, the PDCP* indication shown for each of GTP entity 330B (at BS 134) and GTP entity 330C (at core network 150) 330C in FIG. 3 may, for example, indicate that PDCP sequence numbers may be provided within GTP data units sent from core network 150, or other sequence number information may be provided within the GTP data units to allow the multiple BSs/cells of the MC session to determine a consistent set of PDCP sequence numbers, according to some example implementations. Further details of different example implementations are described below.

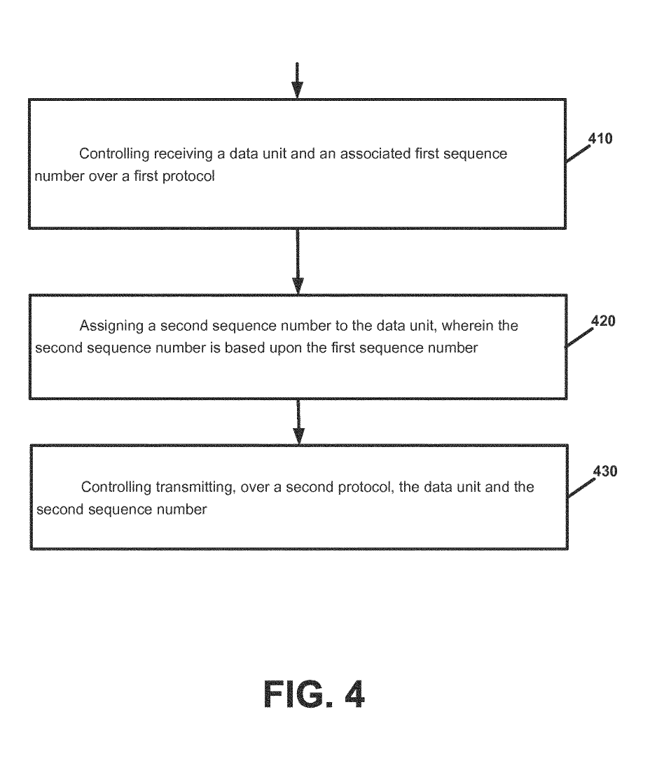

FIG. 4 is a flow chart illustrating operation of a base station according to an example implementation. Operation 410 may include controlling receiving a data unit and an associated first sequence number over a first protocol, assigning a second sequence number to the data unit, wherein the second sequence number is based upon the first sequence number, and controlling transmitting, over a second protocol, the data unit and the second sequence number. In one example implementation, the first protocol may include GTP, and the second protocol may include PDCP (e.g., in a downlink direction). In another example implementation, the first protocol may include PDCP, and the second protocol may include GTP (e.g., in the uplink direction). GTP and PDCP are example protocols and other protocols/protocol entities may be used.

Various example implementations of the method of FIG. 4 will now be briefly described.

In an example implementation of the method of FIG. 4, the second sequence number may be based upon the first sequence number in such a manner that the first sequence number is at least partly derivable from the second sequence number.

In an example implementation of the method of FIG. 4, the controlling transmitting may include controlling transmitting, by a network entity to a user device over a second protocol, the data unit and the second sequence number, wherein the data unit is transmitted as part of a multiple connection session.

In an example implementation of the method of FIG. 4, the controlling transmitting may include controlling transmitting, by a network entity to a multiple connection entity of a core network over a second protocol, the data unit and the second sequence number, wherein the data unit is transmitted as part of a multiple connection session.

In an example implementation of the method of FIG. 4, the controlling receiving may include controlling receiving, by a network entity, a data unit and an associated first protocol sequence number, and the assigning may include assigning, by the network entity, a second protocol sequence number to the data unit, wherein the second protocol sequence number is based upon the first protocol sequence number, and wherein the controlling transmitting may include controlling transmitting, by the network entity to a user device over a second protocol, the data unit and the second protocol sequence number.

In an example implementation of the method of FIG. 4, the controlling receiving may include controlling receiving, by a network entity, a data unit and an associated first protocol sequence number, the assigning may include assigning, by the network entity, a second protocol sequence number to the data unit, wherein the second protocol sequence number is based upon the first protocol sequence number, and wherein the controlling transmitting may include controlling transmitting, by the network entity to a multiple connection entity over a second protocol, the data unit and the second protocol sequence number.

In an example implementation of the method of FIG. 4, the assigning may include determining the second sequence number for the data unit based on the first sequence number, wherein the second sequence number is equal to the first sequence number.

In an example implementation of the method of FIG. 4, the assigning may include determining the second sequence number for the data unit based on the first sequence number, wherein the second sequence number is equal to a group of least significant bits of the first sequence number.

In an example implementation of the method of FIG. 4, the controlling receiving may include controlling receiving, over a first protocol, a first protocol data unit and an associated first protocol sequence number. The method may further include segmenting the first protocol data unit into a plurality of second protocol data units. The assigning may include assigning, based upon the first protocol sequence number, a second protocol sequence number to each of the second protocol data units, and the controlling transmitting may include controlling transmitting, the second protocol data units over the second protocol, each of the second protocol data units including an assigned second protocol sequence number.

In an example implementation of the method of FIG. 4, the controlling receiving may include controlling receiving, over a first protocol, a first protocol data unit and a first protocol sequence number and including one or more fields that include a plurality of second protocol sequence numbers. The method may further include segmenting the first protocol data unit into a plurality of second protocol data units. The assigning may include assigning one of the second protocol sequence numbers to each of the second protocol data units, and the controlling transmitting includes controlling transmitting, over the second protocol, one or more of the second protocol data units, each of the second protocol data units including the assigned second protocol sequence number.

In an example implementation of the method of FIG. 4, the controlling receiving may include controlling receiving, over a first protocol, a plurality of first protocol data units, one or more of the first protocol data units including at least one second protocol sequence number. The method may further include concatenating a plurality of the first protocol data units to generate one or more of the second protocol data units. And, the assigning may include assigning one of the second protocol sequence numbers to each of the second protocol data units, and the controlling transmitting may include controlling transmitting, over the second protocol, one or more of the second protocol data units, each of the second protocol data units including the assigned second protocol sequence number.

In an example implementation of the method of FIG. 4, a network entity provides to a user device a first connection that is part of a multiple connection session for the user device, and wherein the controlling receiving may include: controlling receiving, by the network entity from a multiple connection entity of a core network, a data unit and an associated first sequence number over a first protocol, wherein the data unit is sent from the multiple connection entity to a plurality of network entities that provide services for the multiple connection session for the user device.

In an example implementation of the method of FIG. 4, a multiple connection session is established for a user device, the multiple connection session including a first connection between a first base station and the user device and a second connection between a second base station and the user device, each of the first and second base stations receiving the data unit of the multiple connection session and independently assigning a second sequence number and a third sequence number respectively to the data unit.

In an example implementation, the method of FIG. 4 may further include determining, by a first base station, that an acknowledgement has not been received by the first base station from a user device that acknowledges receiving the data unit, determining, by the first base station, the first sequence number for the data unit, and controlling sending, by the first base station to the second base station, information identifying the first sequence number of the data unit and a request for the second base station to send the data unit to the user device.

According to another example implementation, an apparatus may include at least one processor and at least one memory including computer instructions, when executed by the at least one processor, cause the apparatus to control receiving a data unit and an associated first sequence number over a first protocol, assign a second sequence number to the data unit, wherein the second sequence number is based upon the first sequence number, and control transmitting, over a second protocol, the data unit and the second sequence number.

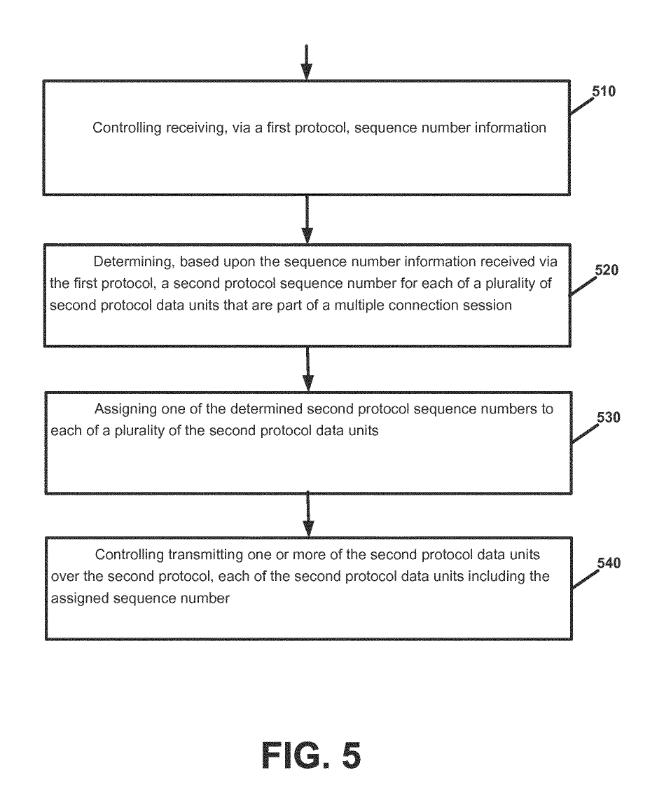

According to an example implementation, a computer program product may include a computer-readable storage medium and storing executable code that, when executed by at least one data processing apparatus, is configured to cause the at least one data processing apparatus to perform a method of either FIG. 4 or 5.

For example, a computer program product may include a computer-readable storage medium and storing executable code that, when executed by at least one data processing apparatus, is configured to cause the at least one data processing apparatus to perform a method including controlling receiving a data unit and an associated first sequence number over a first protocol, assigning a second sequence number to the data unit, wherein the second sequence number is based upon the first sequence number, and controlling transmitting, over a second protocol, the data unit and the second sequence number.

FIG. 5 is a flow chart illustrating operation of a network entity according to another example implementation. Operation 510 may include controlling receiving, via a first protocol, sequence number information. Operation 520 may include determining, based upon the sequence number information received via the first protocol, a second protocol sequence number for each of a plurality of second protocol data units that are part of a multiple connection session. Operation 530 may include assigning one of the determined second protocol sequence numbers to each of a plurality of the second protocol data units. Operation 540 may include controlling transmitting one or more of the second protocol data units over the second protocol, each of the second protocol data units including the assigned sequence number.

According to an example implementation, the method of FIG. 5 may include controlling receiving, by a network entity from a multiple connection entity via a first protocol, sequence number information, determining, by the network entity based upon the sequence number information received via the first protocol, a second protocol sequence number for each of a plurality of second protocol data units that are part of a multiple connection session between the multiple connection entity and a user device, assigning, by the network entity, one of the determined second protocol sequence numbers to each of a plurality of the second protocol data units, and controlling transmitting, by the network entity to the user device, one or more of the second protocol data units over the second protocol, each of the second protocol data units including the assigned sequence number.

In an example implementation, the method of FIG. 5 may include controlling receiving, by a network entity from user device via a first protocol, sequence number information, determining, by the network entity based upon the sequence number information received via the first protocol, a second protocol sequence number for each of a plurality of second protocol data units that are part of a multiple connection session between a multiple connection entity and the user device, assigning, by the network entity, one of the determined second protocol sequence numbers to each of a plurality of the second protocol data units, and controlling transmitting, by the network entity to the multiple connection entity, one or more of the second protocol data units over the second protocol, each of the second protocol data units including the assigned sequence number.

In an example implementation of the method of FIG. 5, the sequence number information may include at least a first protocol sequence number for a first protocol data unit, wherein the determining may include performing one of the following: determining, based upon the first protocol sequence number for the first protocol data unit, the second protocol sequence number for at least one second protocol data unit, wherein the second protocol sequence number is equal to the first sequence number; and determining, based upon the first protocol sequence number for the first protocol data unit, the second protocol sequence number for at least one second protocol data unit, wherein the second protocol sequence number is equal to a group of least significant bits of the first protocol sequence number.

In an example implementation of the method of FIG. 5, the controlling receiving may include controlling receiving a first protocol data unit that includes sequence number information, wherein the sequence number information includes: a first protocol sequence number for the first protocol data unit; and one or more fields in the first protocol data unit that include a second protocol sequence number to be assigned to a second protocol data unit associated with the first protocol data unit.

In an example implementation of the method of FIG. 5, the sequence number information comprises at least a first protocol sequence number for a first protocol data unit, and further comprising: determining, by the network entity based upon the first protocol sequence number for the first protocol data unit, a second protocol sequence number for a second protocol data unit, storing, by the network entity, an association between the first protocol sequence number for the first protocol data unit and the second protocol sequence number for the second protocol data unit, determining, by the first network entity, that an acknowledgement has not been received from the user device acknowledging receipt of the first protocol data unit, determining, by the first network entity based on the association, the second protocol sequence number associated with the first protocol sequence number, and controlling sending, by the first network entity to a second network entity, information identifying the second protocol sequence number of the second protocol data unit and a request for the second network entity to send the second protocol data unit to the user device.

According to an example implementation, an apparatus may include at least one processor and at least one memory including computer instructions, when executed by the at least one processor, cause the apparatus to: control receiving, via a first protocol, sequence number information, determine, based upon the sequence number information received via the first protocol, a second protocol sequence number for each of a plurality of second protocol data units that are part of a multiple connection session, assign one of the determined second protocol sequence numbers to each of a plurality of the second protocol data units, and control transmitting one or more of the second protocol data units over the second protocol, each of the second protocol data units including the assigned sequence number.

According to an example implementation, a computer program product may include a non-transitory computer-readable storage medium and storing executable code that, when executed by at least one data processing apparatus, is configured to cause the at least one data processing apparatus to perform a method including: controlling receiving, via a first protocol, sequence number information, determining, based upon the sequence number information received via the first protocol, a second protocol sequence number for each of a plurality of second protocol data units that are part of a multiple connection session, assigning one of the determined second protocol sequence numbers to each of a plurality of the second protocol data units, and controlling transmitting one or more of the second protocol data units over the second protocol, each of the second protocol data units including the assigned sequence number.

According to another example implementation, an apparatus may include means for performing any of the operations described with respect to FIG. 4 or 5, or otherwise operations described herein.

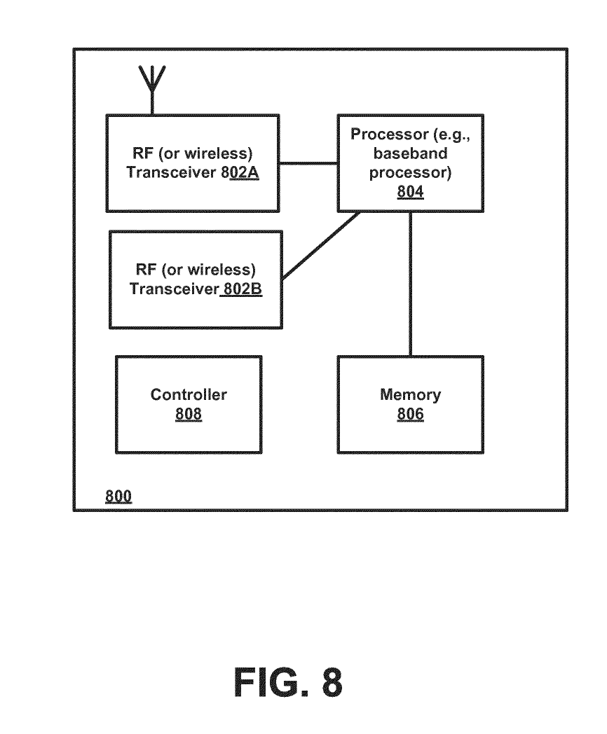

According to an example implementation, a computer program product (such as, for example, a memory 806, FIG. 8) for a computer may include software code portions for performing the steps of any of the example implementations, methods or steps described herein, including for performing the methods described in either of FIGS. 4 and 5 and/or for performing the further example implementations described based on the methods of FIGS. 4 and 5, or for performing any of the method claims listed herein, when the software code portions of the computer program product are run on the computer.

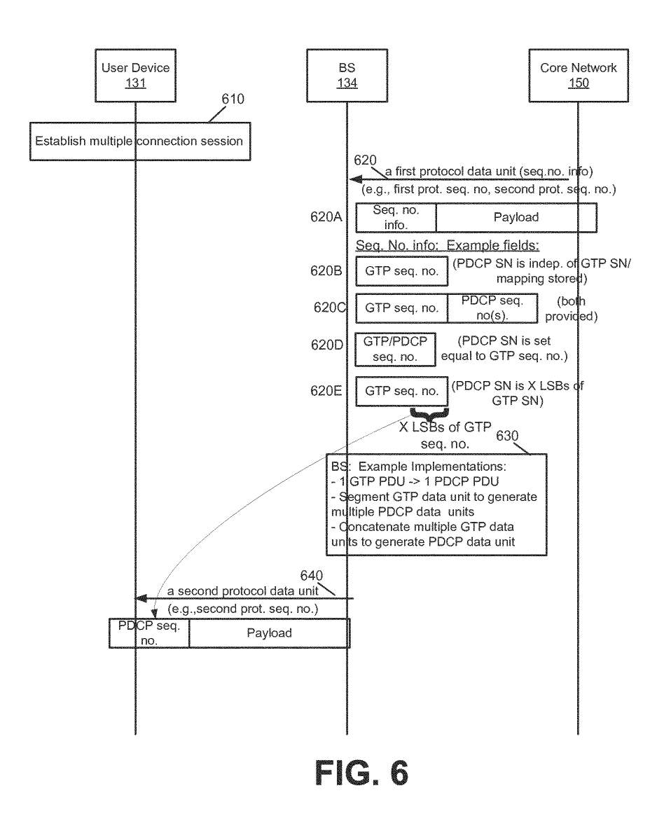

FIG. 6 is a diagram illustrating operation of a base station according to an example implementation. At 610, user device 131 may establish a multiple connection (MC) session between the user device 131 and core network 150 via BS 134/cell 136 and BS 144/cell 146 (not shown). For the MC session, the core network may forward a copy of the data units of the MC session to each BS 134, 144.

At 620, BS 134 may receive a first protocol data unit (e.g., a GTP data unit), including sequence number information. GTP is merely one example of a first protocol, and other protocols may be used. Although not shown, the other BSs/cells (including BS 144/cell 146) of the MC session may also receive the data units of the MC session via the first protocol, e.g., via GTP.

The sequence number information that may be included within the first protocol data unit at 620 may include a number of different formats, or include different information or fields, according to different implementations, some of which are illustrated with reference to 620A, 620B, 620C, 620D and 620E. In general, as shown at 620A, the first protocol data unit may include a header with one or more fields, and a payload (including data). The header may include the sequence number information. 620B, 620C, 620D and 620E in FIG. 6 illustrate some example fields that may be included within the sequence number information.

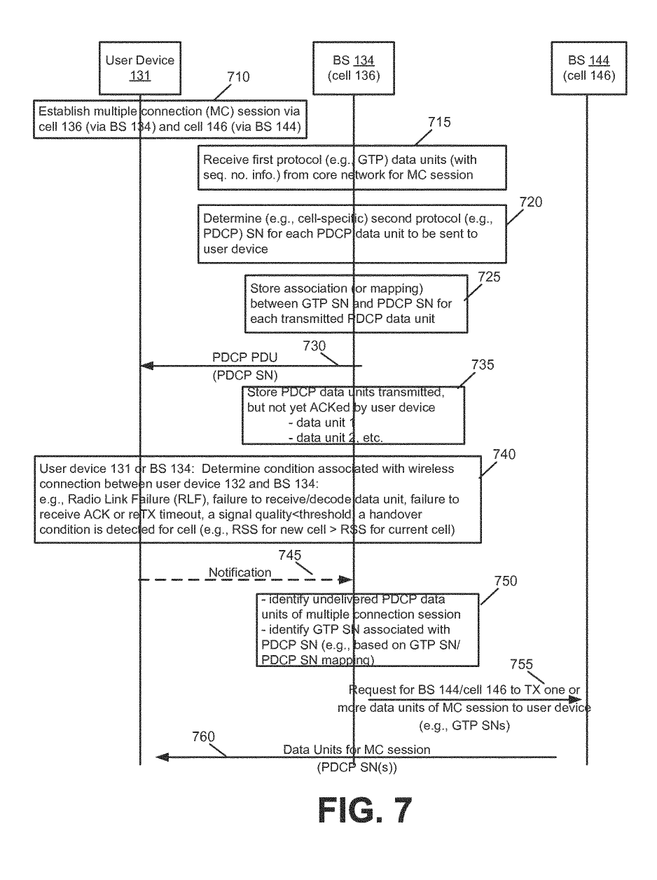

At 620B, the sequence number information may include a first protocol sequence number (or GTP sequence number) for the GTP data unit received by the BS 134. Thus, at 620B, the sequence number information may, for example, include a GTP sequence number that identifies a sequence number for the GTP data unit received by BS 134. In this example, after BS 134 receives this GTP data unit with the GTP sequence number, the BS 134 may independently generate a cell-specific second protocol sequence number (e.g., PDCP sequence number) for a second protocol data unit (e.g., PDCP data unit) to be sent to user device 131, e.g., to forward the data received from core network 150 via GTP to the user device 131 via PDCP. The BS 134 may store in memory a mapping or association between the first protocol sequence number (e.g., GTP sequence number of the GTP data unit received by the BS 134) and the second protocol sequence number (e.g., PDCP sequence number of the corresponding PDCP data unit to be sent to the user device). According to an example implementation, and as described in greater detail with respect to FIG. 7, user device 131 and BS 134 may reference or identify data units by referencing the second protocol (e.g., PDCP) sequence numbers, while BS 134/cell 136 and BS 144/cell 146 may identify data units as between BSs (cell-to-cell, or BS-to-BSs communications) by referencing the first protocol (e.g., GTP) sequence numbers because both cells/BSs of the MC session have received the same first protocol (e.g., GTP) sequence numbers and data units, although in this example, each cell may assign separate/different second protocol (e.g., PDCP) sequence numbers.

At 630, some different possible implementations are identified regarding the generation (by BS 134) of a second protocol (e.g., PDCP) data unit based on a received first protocol (e.g., GTP) data unit. First, there may be one second protocol (e.g., PDCP) data unit for each first protocol (e.g., GTP) data unit. In such case, the stored mapping or association may include one second protocol sequence number for each first protocol sequence number. Secondly, the payload of the first protocol (e.g., GTP) data unit may be larger than what can be transmitted over a second protocol (e.g., PDCP) data unit. In such case, the first protocol data unit (payload of such data unit) may be segmented into multiple second protocol data units. Thus, in this segmenting case, there may typically be multiple second protocol (e.g., PDCP) sequence numbers for each first protocol (e.g., GTP) sequence number. Thirdly, multiple first protocol data units (or payloads from multiple first protocol data units) may be concatenated into one second protocol data unit. Thus, as an example of this third case, multiple GTP data units/payloads may be concatenated to form a payload to be sent via one PDCP data unit, for example.

At 640, the second protocol sequence number (e.g., PDCP sequence number) may then be copied to a header or sequence number field of the second protocol (e.g., PDCP) data unit, and the second protocol data unit may be sent or transmitted via the wireless connection to user device 131.

Other example implementations, shown as 620C, 620D, 620E, either provide a second protocol (e.g., PDCP) sequence number(s) within a first protocol (e.g., GTP) data unit, or may provide information within a first protocol (e.g., GTP)data unit that may allow each BS to determine a same or common set of second protocol (e.g., PDCP) sequence number(s).

In 620C, the sequence number information includes both a first protocol (e.g., GTP) sequence number for the first protocol data unit, and a second protocol (e.g., PDCP) sequence number(s), e.g., as separate fields in the header of the first protocol data unit. In an illustrative example, GTP entity 330C at the core network (or at MC anchor 252) may generate the PDCP sequence number(s), and send the GTP data unit (including GTP sequence number for the GTP data unit, corresponding PDCP sequence number(s), and GTP data/payload) to the GTP entity 330B at each cell/BS (e.g., BS 134/cell 136 and BS 144/cell 146) configured to provide the multiple connection (MC) session for the user device. In an example implementation, a flag or control bit may be set within the GTP data unit, or provided via a control channel, by GTP entity 330C or core network 150, to indicate to BS 134/GTP entity 330B that PDCP sequence numbers are being provided within the GTP data unit(s), for example.

620D and 620E are similar to 620C. For 620D, the first protocol (e.g., GTP) data unit may only include a first protocol (e.g., GTP) sequence number, and does not necessarily include a separate second protocol (e.g., PDCP) sequence number. And, the first protocol sequence number may be used by the BS for the sequence number for the second protocol (e.g., PDCP) data unit. In this case, for example, based on a flag or control signal that may be provided within the data unit or via a control channel indicating that GTP sequence number should be used as the PDCP sequence number, GTP entity 330B at BS 134 may then copy the GTP sequence number of the received GTP data unit into the PDCP sequence number for a PDCP data unit that is sent by PDCP entity 240B to user device 131.

In 620E, GTP entity 330B of BS 134 may receive, for example, only a GTP sequence number, and not a separate PDCP sequence number, within the received GTP data unit. However, in 620E, the GTP entity 330B of BS 134 may determine a PDCP sequence number (for a corresponding PDCP data unit) as a group of X least significant bits (e.g., X LSBs) of the GTP sequence number, where X is some number. This group of LSBs of the GTP sequence number may then be copied by GTP entity 330B into a PDCP sequence number field for a PDCP data unit to be transmitted by BS 134 to user device 131, as shown by 640 (FIG. 6). Thus, 620E may allow a common or same set of PDCP sequence numbers to be specified to both BSs/cell of a MC session via GTP data units and GTP sequence numbers, while accommodating shorter PDCP sequence numbers (e.g., shorter than the GTP sequence numbers).

After receiving the GTP data unit, GTP entity 330B (including PDCP sequence numbering functions) at the BS 134 may then, for example, operate as a relay or interface between the GTP entity 330C at core network 150 and the PDCP entity 240B at BS 134. Thus, GTP entity 330B at BS 134/cell 136 may, for example, copy a PDCP sequence number that was received in the GTP header of (or determined based on information in) the received GTP data unit into a PDCP sequence number field for each PDCP data unit to be sent/transmitted to the user device 131. PDCP entity 240B may then send the PDCP data units, including the PDCP sequence number(s), to a peer PDCP entity 240A at user device 131, as shown by 640.

Thus, by the core network 150 or MC anchor 252 including either 1) PDCP sequence number(s) within one or more GTP data units, or 2) information (via the alternative options shown at 620) that allows both BSs/cells of the MC session to determine a same or common set of PDCP sequence numbers, this keeps the PDCP sequence numbers consistent among multiple BSs/cells that have been configured for a MC session for user device 131.

With respect to 630 in FIG. 6, there may be a 1:1 ratio of GTP sequence number to PDCP sequence number, a 1:N (with N>1) ratio of one GTP sequence number to N PDCP sequence numbers (where GTP data unit/payload is segmented to form multiple PDCP data units), or a N:1 ratio (in the case of concatenating multiple GTP data units/payloads to form a PDCP data unit). For the N:1 (concatenating case), multiple GTP data units may include the same PDCP sequence number, or one of a plurality of GTP data unit may include a common PDCP sequence number. In the case where a received GTP data unit/payload is segmented to form multiple PDCP data units, the received GTP data unit may include either multiple PDCP sequence numbers (e.g., one PDCP sequence number for each segment/PDCP data unit). Alternatively, in the case of GTP segmentation, the received GTP data unit may include, for example, only one PDCP sequence number for a first segment/PDCP data unit, and BS 134/GTP entity 330B may determine one or more next sequential PDCP sequence numbers from this received PDCP sequence number for one or more additional segments, for example. Thus, in the GTP segmentation case, for example, PDCP 330B may receive a PDCP sequence number for a first PDCP data unit (or first segment), and then may determine PDCP SNs for 2^{nd}, 3^{rd}, 4^{th}, . . . PDCP data units to be transmitted from this GTP payload.

Network 300 may also operate to process and transmit uplink data units for a multiple connection session in a manner that is similar to that described above for the processing and transmission/sending of downlink data units for a multiple connection session. However, the processing of uplinks data units would occur in a direction that is opposite than downlink data units.

For example, in an uplink direction, a user device 131 may number data units or packets in a contiguous manner with a PDCP sequence number for each data unit. The user device may then send the data units to the MC anchor 252 (or to core network 150) via a plurality of BSs, e.g., via BS 134 and BS 144. In a simple illustrative example, data units having odd PDCP sequence numbers may be sent from the user device 131 via BS 134 to MC anchor 252, while data units having even PDCP sequence numbers may be sent from the user device 131 via BS 144 to MC anchor 252. In an example implementation, each BS of the multiple connection session, e.g., BSs 134 and 144, may determine a GTP sequence number for each received PDCP data unit based on the PDCP sequence number of the data unit, using a same (or common) technique or approach for determining the GTP sequence number, e.g., which may be the same as the techniques described in FIG. 6 with respect to the downlink direction. For example, a GTP sequence number may be set to be the same as a received PDCP sequence number (e.g., 620D), or a GTP sequence number may be set equal to X least significant bits (LSBs) of the PDCP sequence number (e.g., 620E). Both (all) BSs of the multiple connection session may typically use the same approach or technique for determining GTP sequence numbers, e.g., using one of the techniques illustrated in FIG. 6, for example. Each PDCP data unit may have a different PDCP sequence number. Therefore, each GTP sequence number should or will be different, even among multiple BSs. Thus, there may be gaps in PDCP sequence numbers and in GTP sequence numbers from the perspective of each BS (since data units are numbered consecutively by user device 131 and then sent via multiple BSs), but this is fine, and does not impact the BS's determining of a GTP sequence number for each data unit. The data units may arrive, e.g., out of order, at the MC anchor 252, and the MC anchor 252 may use the GTP sequence numbers to reorder the GTP data units into the correct order before passing the data up to one or more upper layers for processing or forwarding the data to host 310, for example. An example uplink processing that may be performed at one of the BSs will be briefly described.

In an illustrative example implementation, for uplink processing and transmission, BS 134/cell 136 may receive a first protocol (e.g., PDCP) data unit and an associated first protocol (e.g., PDCP) sequence number from user device 131. For example, PDCP entity 240B at BS 134 may receive a PDCP data unit with a PDCP sequence number from PDCP entity 240A of user device 131. GTP/PDCP* entity 330B may receive the uplink PDCP data unit and may determine a second protocol (e.g., GTP) sequence number that is based upon (or which is at least partly derivable from) the first protocol sequence number. For example, for this uplink data PDPG unit, a GTP sequence number may be determined that is the same as (or equal to) the PDCP sequence number, or the GTP sequence number may be equal to a group of least significant bits of the PDCP sequence number of the received uplink PDCP data unit. In other example implementations, the first protocol (e.g., PDCP) data unit may be segmented into multiple second protocol (e.g., GTP) data units, or multiple first protocol (e.g., PDCP) data units received by the BS 134 from the user device may be concatenated into one second protocol (e.g., GTP) data unit. GTP/PDCP* entity 330B may transmit the second protocol data unit(s), each with a second protocol (e.g., GTP) sequence number to core network 150 (or to S-GW/P-GW, or to MC anchor). MC anchor or core network 150 may similarly receive uplink data units from other BSs or network entities that are providing service of a multiple connection session between core network 150 and a user device 131. FIG. 7 is a diagram illustrating operation of base stations of a multiple connection session according to an example implementation. A first wireless connection may be established between the user device 131 and BS 134/cell 136. A second wireless connection may be established between user device 131 and BS 144/cell 146. At 710, a multiple connection (MC) session is established between user device 131 and core network 150 (not shown) via BS134/cell 136 and BS 144/cell 146, for example.

At 715, BS 134 may receive from core network 150 a first protocol (e.g., GTP) data unit, including sequence number information (e.g., which may include a GTP sequence number) according to a format or including fields as described in one of the examples shown in FIG. 6, e.g., according to one of 620A, 620B, 620C, 620D or 620E, as examples. In one illustrative example, at 720, each BS/cell may determine a cell-specific second protocol (e.g., PDCP) sequence number for each PDCP data unit to be transmitted to user device 131. In an illustrative example, BS 134/cell 136 may determine or assign a first PDCP sequence number for a PDCP data unit, and BS 144/cell 146 may (independently or separately from BS 134.cell 134) determine or assign a second PDCP sequence number for the same PDCP data unit.

At 725, each BS/cell of the MC session may store an association or mapping between the sequence number of the first (e.g., GTP) protocol data unit and the sequence number of the second protocol (e.g., PDCP) data unit that corresponds to the first protocol data unit. For example, BS 134/cell 136 may store in memory an association or mapping between the GTP sequence number for the GTP data unit received (received by BS 134 at 715) by the BS 134 from the core network 150 and the first PDCP sequence number (determined by BS 134 at 720) assigned to the PDCP data unit by the BS 134/cell 136. Similarly, BS 144/cell 146 may store in a local memory an association or mapping between the GTP sequence number for the received GTP data unit (received by BS 144 at 715) and the second PDCP sequence number (determined by BS 144 at 720) assigned to the PDCP data unit by BS 144/cell 146. Each BS/cell of a MC session may store an association or mapping for a plurality of (or multiple) GTP data units and PDCP data units, for example.

The mapping or association stored in memory at 725 may take into account the possibility that a received GTP data unit (or payload) may be segmented or concatenated, as described with reference to FIG. 6. Thus, at 725, in the stored mapping or association, for GTP segmentation, multiple PDCP sequence numbers may be associated with or mapped to one GTP sequence number. And, for GTP concatenation (concatenating multiple GTP payloads to form one PDCP data unit), there may be one PDCP sequence number mapped to or associated with multiple GTP sequence numbers, for example.

At 730, BS 134/cell 136 may send one or more PDCP data units to the user device 131, e.g., each PDCP data unit including a PDCP sequence number. As a PDCP data unit is acknowledged as being received (e.g., acknowledged by either the user device 131 or one or more other BSs/cells of the MC session), the BS/cell may delete such PDCP data unit from its buffers. Thus, as 735, each BS may store one or more PDCP data units, e.g., data unit 1, data unit 2, that have been transmitted by the BS/cell but not yet acknowledged as being received by the user device 131.

At 740, according to an example implementation, user device 131 or BS 134/cell 136 may determine a condition associated with the wireless connection between the user device 131 and BS 134/cell 136. The detected condition may include, by way of example: a radio link failure (RLF), a failure to receive/decode a data unit(s), a failure to receive an ACK (acknowledgement) or a timer expiration for a retransmission timer after N number of retransmission retries, a signal quality of the wireless channel or wireless connection being less than a threshold (e.g., which may be due to movement of user device 131 away from BS), or a handover condition detected for the cell (e.g., received signal strength of a new cell is greater than the received signal strength of the current cell 136).

For example, detecting at 740 one or more of these conditions associated with the wireless connection between user device 131 and cell 136 may indicate that one or more PDCP data units allocated to BS 134/cell 136 for transmission to user device 131 should be re-assigned or re-allocated to another BS/cell of the MC session for transmission/retransmission, e.g., due to the detected condition/problem with cell 136.

At 745, the user device 131 may send a notification of the detected condition to the BS 134/cell 136, if such condition was detected by user device 131. This may include notifying BS 134 of a handover request/indication, or of a signal strength for the wireless connection that is less than a threshold, etc.

At 750, BS 134/cell 136 may identify one or more PDCP data units, which were requested to be sent to user device 131 from BS 134/cell 136, but which remain unsent or undelivered to user device 131. Based on a PDCP sequence number for these one or more PDCP data units, and the mapping or association stored at 725 by BS 134/cell 136, BS 134 may identify a GTP sequence number corresponding to each of one or more local PDCP sequence numbers. For example, based on the mapping/association stored by BS 134, the BS 134/cell 136 may determine the GTP sequence number that corresponds to the first PDCP sequence number, where the first PDCP sequence number may be a local PDCP sequence number that may be specific to BS 134/cell 136.

At 755, the BS 134/cell 136 may send to BS 144/cell 146 a request to send one or more data units to the user device, and include the GTP sequence number for the requested data units. Note, that according to an example implementation, BS 134/cell 136 does not include the first PDCP sequence number (and other PDCP sequence numbers local to the BS 134/cell 136) because BS 144/cell 146 may use a different or independently assigned set of PDCP sequence number for data units sent by BS 144/cell 146 to user device 131. Thus, in this illustrative example, based on the separate or independent assignment or sets of PDCP sequence numbers by each BS/cell of the MC session, a BS/cell may identify or reference data (data units) to another BS/cell of the MC session by GTP sequence number. The BS 144/cell 146 may then determine, based on a locally stored mapping or association of GTP sequence numbers (SN(s)) to PDCP SN(s), one or more local PDCP sequence numbers that correspond to the identified GTP data unit sequence numbers. At 760, BS 144/cell 146 may send the identified PDCP data units to user device 131, with the locally assigned (assigned by BS 144/cell 146) PDCP SN(s).

In this manner, by using the local GTP SN/PDCP SN mapping/association at each BS/cell of the MC session, coordination or communication between cells or BSs may be provided within the MC session, even when different PDCP sequence numbers are used by each BS/cell.

FIG. 8 is a block diagram of a wireless station (e.g., BS or user device) 800 according to an example implementation. The wireless station 800 may include, for example, two RF (radio frequency) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

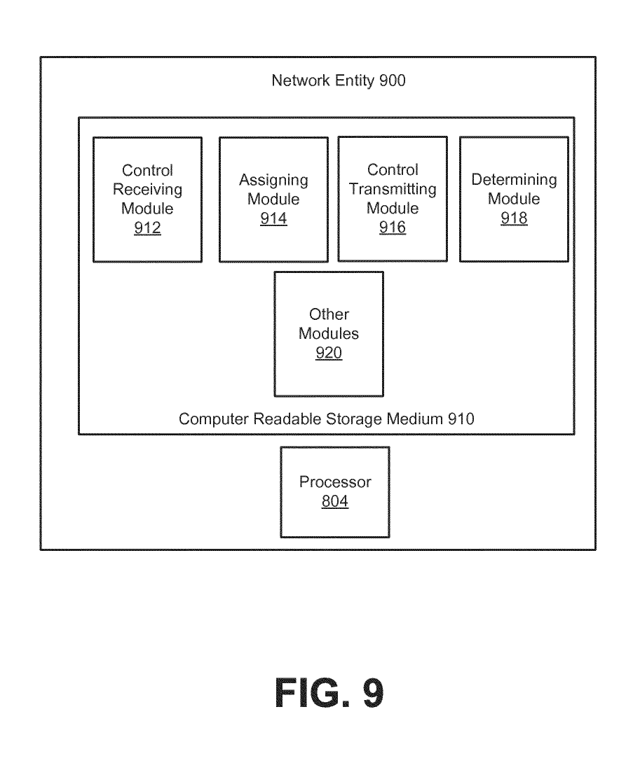

FIG. 9 is a block diagram illustrating a network entity 900 according to an example implementation. An example network entity 900 may include a processor 804, and may include a computer-readable storage medium 910. Network entity 900 may include logic for performing one or more of the various functions or operations described herein. In an illustrative example implementation, the computer-readable storage medium 910 may store or provide the logic, which may be provided as computer instructions or executable code that may be executed by the processor 804. According to an example implementation, the instructions or executable code may be provided as one or more logic blocks or modules that may be executed by the processor 804 to perform various functions, operations or methods described herein. The example blocks or modules, which may be stored in computer-readable storage medium 910 and executed by processor 804, may include, for example, a control receiving module 912, an assigning module 914, a control transmitting module 916, and a determining module 918. Other modules 920 or logic blocks are also provided for performing the other functions or operations described herein.

According to an example implementation, when executed by processor 804: the control receiving module 912 may control receiving a data unit and an associated first sequence number over a first protocol; the assigning module 914 may assign a second sequence number to the data unit, wherein the second sequence number is based upon the first sequence number, and the control transmitting module 916 may control transmitting, over a second protocol, the data unit including the second sequence number.

According to an example implementation, when executed by processor 804: the control receiving module 912 may control receiving, via a first protocol, sequence number information; the determining module 918 may determine, by the network entity based upon the sequence number information received via the first protocol, a second protocol sequence number for each of a plurality of second protocol data units that are part of a multiple connection session; the assigning module 914 may assign, by the network entity, one of the determined second protocol sequence numbers to each of a plurality of the second protocol data units; and the control transmitting module 916 may control transmitting, by the network entity to the user device, one or more of the second protocol data units over the second protocol to a user device, each of the second protocol data units including the assigned sequence number.

An example of an apparatus may also include means (804, 802A/802B, and/or 912) for controlling receiving a data unit with an associated first sequence number over a first protocol, means (804, 802A/802B, and/or 914) for assigning a second sequence number to the data unit, wherein the second sequence number is based upon the first sequence number, and means (804, 802A/802B, and/or 916) for controlling transmitting the data unit and the second sequence number over a second protocol.

Another example of an apparatus may include means (804, 802A/802B, and/or 912) for controlling receiving, via a first protocol, sequence number information, means (804, and/or 918) for determining, based upon the sequence number information received via the first protocol, a second protocol sequence number for each of a plurality of second protocol data units that are part of a multiple connection session, means (804, and/or 914) for assigning one of the determined second protocol sequence numbers to each of a plurality of the second protocol data units, and means (804, 802A/802B, and/or 916) for controlling transmitting one or more of the second protocol data units over the second protocol to a user device, each of the second protocol data units including the assigned sequence number.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-30. (canceled)

31. A method comprising:
controlling receiving a data unit and an associated first sequence number over a first protocol;
assigning a second sequence number to the data unit, wherein the second sequence number is based upon the first sequence number; and
controlling transmitting, over a second protocol, the data unit and the second sequence number.

32. The method of claim 31, wherein the second sequence number is based upon the first sequence number in such a manner that the first sequence number is at least partly derivable from the second sequence number.

33. The method of claim 31, wherein the controlling transmitting comprises:
controlling transmitting by a network entity over a second protocol, the data unit and the second sequence number, to at least one of a user device and a multiple connection entity of a core network, wherein the data unit is transmitted as part of a multiple connection session.

34. The method of claim 31,
wherein the controlling receiving comprises controlling receiving, by a network entity, a data unit and an associated first protocol sequence number;
wherein the assigning comprises assigning, by the network entity, a second protocol sequence number to the data unit, wherein the second protocol sequence number is based upon the first protocol sequence number; and
wherein the controlling transmitting comprises controlling transmitting over a second protocol, by the network entity to at least one of a user device and a network entity, the data unit and the second protocol sequence number.

35. The method of claim 31, wherein the assigning comprises:
determining the second sequence number for the data unit based on the first sequence number, wherein the second sequence number is equal to the first sequence number or equal to a group of least significant bits of the first sequence number.

36. The method of claim 31, wherein:
the controlling receiving comprises controlling receiving, over a first protocol, a first protocol data unit and an associated first protocol sequence number;
the method further comprising segmenting the first protocol data unit into a plurality of second protocol data units;
the assigning comprises assigning, based upon the first protocol sequence number, a second protocol sequence number to each of the second protocol data units; and
the controlling transmitting comprises controlling transmitting, the second protocol data units over the second protocol, each of the second protocol data units including an assigned second protocol sequence number.

37. The method of claim 31, wherein:
the controlling receiving comprises controlling receiving, over a first protocol, a first protocol data unit and a first protocol sequence number and including one or more fields that include a plurality of second protocol sequence numbers;
the method further comprising segmenting the first protocol data unit into a plurality of second protocol data units;
the assigning comprises assigning one of the second protocol sequence numbers to each of the second protocol data units; and
the controlling transmitting comprises controlling transmitting, over the second protocol, one or more of the second protocol data units, each of the second protocol data units including the assigned second protocol sequence number.

38. The method of claim 31, wherein:
the controlling receiving comprises controlling receiving, over a first protocol, a plurality of first protocol data units, one or more of the first protocol data units including at least one second protocol sequence number;
the method further comprising concatenating a plurality of the first protocol data units to generate one or more of the second protocol data units;
the assigning comprises assigning one of the second protocol sequence numbers to each of the second protocol data units; and
the controlling transmitting comprises controlling transmitting, over the second protocol, one or more of the second protocol data units, each of the second protocol data units including the assigned second protocol sequence number.

39. The method of claim 31, wherein a network entity provides to a user device a first connection that is part of a multiple connection session for the user device, and wherein the controlling receiving comprises:
controlling receiving, by the network entity from a multiple connection entity of a core network, a data unit and an associated first sequence number over a first protocol, wherein the data unit is sent from the multiple connection entity to a plurality of network entities that provide services for the multiple connection session for the user device.

40. The method of claim 31, wherein a multiple connection session has been established for a user device, the multiple connection session including a first connection between a first base station and the user device and a second connection between a second base station and the user device, each of the first and second base stations receiving the data unit of the multiple connection session and independently assigning a second sequence number and a third sequence number respectively to the data unit.

41. An apparatus comprising at least one processor and at least one memory including computer instructions which, when executed by the at least one processor, cause the apparatus to:
control receiving a data unit and an associated first sequence number over a first protocol;
assign a second sequence number to the data unit, wherein the second sequence number is based upon the first sequence number; and
control transmitting, over a second protocol, the data unit and the second sequence number.

42. The apparatus of claim 41, wherein the second sequence number is based upon the first sequence number in such a manner that the first sequence number is at least partly derivable from the second sequence number.

43. The apparatus of claim 41, wherein the control transmitting comprises control transmitting, by a network entity over a second protocol, to at least one of a user device and a multiple connection entity of a core network, the data unit and the second sequence number, wherein the data unit is transmitted as part of a multiple connection session.

44. The apparatus of claim 41 wherein the control receiving comprises control receiving, by a network entity, a data unit and an associated first protocol sequence number;
wherein the assign comprises assign, by the network entity, a second protocol sequence number to the data unit, wherein the second protocol sequence number is based upon the first protocol sequence number; and
wherein the control transmitting comprises control transmitting, by the network entity over a second protocol, to a user device or a multiple connection entity of a core network, the data unit and the second protocol sequence number.

45. The apparatus of claim 41 wherein the assign comprises:
determine the second sequence number for the data unit based on the first sequence number, wherein the second sequence number is equal to the first sequence number or
determine the second sequence number for the data unit based on the first sequence number, wherein the second sequence number is equal to a group of least significant bits of the first sequence number.

46. The apparatus of claim 41, wherein:
the control receiving comprises control receiving, over a first protocol, a first protocol data unit and an associated first protocol sequence number;
the apparatus being further caused to: segment he first protocol data unit into a plurality of second protocol data units;
the assign comprises assign, based upon the first protocol sequence number, a second protocol sequence number to each of the second protocol data units; and
the control transmitting comprises control transmitting, the second protocol data units over the second protocol, each of the second protocol data units including an assigned second protocol sequence number.

47. The apparatus of claim 41, wherein:
the control receiving comprises: control receiving, over a first protocol, a first protocol data unit and a first protocol sequence number and include one or more fields that include a plurality of second protocol sequence numbers;
the apparatus being further caused to: segment the first protocol data unit into a plurality of second protocol data units;
the assign comprises assign one of the second protocol sequence numbers to each of the second protocol data units; and
the control transmitting comprises control transmitting, over the second protocol, one or more of the second protocol data units, each of the second protocol data units including the assigned second protocol sequence number.

48. The apparatus of claim 41, wherein:
the control receiving comprises control receiving, over a first protocol, a plurality of first protocol data units, one or more of the first protocol data units including at least one second protocol sequence number;
the apparatus being further caused to: concatenate a plurality of the first protocol data units to generate one or more of the second protocol data units;
the assign comprises assign one of the second protocol sequence numbers to each of the second protocol data units; and
the control transmitting comprises control transmitting, over the second protocol, one or more of the second protocol data units, each of the second protocol data units including the assigned second protocol sequence number.

49. The apparatus of claim 41 wherein a network entity provides to a user device a first connection that is part of a multiple connection session for the user device, and wherein the control receiving comprises:
control receiving, by the network entity from a multiple connection entity of a core network, a data unit and an associated first sequence number over a first protocol, wherein the data unit is sent from the multiple connection entity to a plurality of network entities that provide services for the multiple connection session for the user device.

50. The apparatus of claim 41, wherein a multiple connection session has been established for a user device, the multiple connection session including a first connection between a first base station and the user device and a second connection between a second base station and the user device, each of the first and second base stations receiving the data unit of the multiple connection session and independently assigning a second sequence number and a third sequence number respectively to the data unit.

51. An apparatus comprising at least one processor and at least one memory including computer instructions which, when executed by the at least one processor, cause the apparatus to:
control receiving, via a first protocol, sequence number information;
determine, based upon the sequence number information received via the first protocol, a second protocol sequence number for each of a plurality of second protocol data units that are part of a multiple connection session;
assign one of the determined second protocol sequence numbers to each of a plurality of the second protocol data units; and
control transmitting one or more of the second protocol data units over the second protocol, each of the second protocol data units including the assigned sequence number.

52. The apparatus of claim 51 wherein the sequence number information comprises at least a first protocol sequence number for a first protocol data unit, wherein the determine comprises causing the apparatus to:
determine, based upon the first protocol sequence number for the first protocol data unit, the second protocol sequence number for at least one second protocol data unit, wherein the second protocol sequence number is equal to the first sequence number or is equal to a group of least significant bits of the first protocol sequence number.

53. The apparatus of claim 51 wherein the control receiving comprises control receiving a first protocol data unit that includes sequence number information, wherein the sequence number information comprises:
a first protocol sequence number for the first protocol data unit; and
one or more fields in the first protocol data unit that include a second protocol sequence number to be assigned to a second protocol data unit associated with the first protocol data unit.
